(19) United States
(12) Patent Application Publication
(10) Pub. No.: US 2014/0010050 A1
(43) Pub. Date: Jan. 9, 2014

(54) DISTANCE DETECTION ALARM SYSTEM

(71) Applicant: Brian DeAngelo, ST.CHARLES, IL (US)

(72) Inventor: Brian DeAngelo, ST.CHARLES, IL (US)

(21) Appl. No.: 13/934,838

(22) Filed: Jul. 3, 2013

Related U.S. Application Data
(60) Provisional application No. 61/667,860, filed on Jul. 3, 2012.

(51) Int. Cl. G08B 13/16

(52) U.S. Cl. CPC G08B 13/1618
USPC 367/112

(57) ABSTRACT

An alarm system with a detecting device. The detecting device includes an ultrasonic sound wave transmitter and receiver. The transmitter transmits an ultrasonic sound, an object reflects the ultrasonic sound, and the receiver receives the ultrasonic sound. A distance is determined between the object and the detecting device and is stored. The detecting device continually determines the distance using the ultrasonic sound waves and if a different distance is detected, the detecting device triggers an alarm.

### BACKGROUND OF THE INVENTION

The present invention relates to a detection device and, more particularly, to a detection device that measures a distance between the detection device and an object.

Currently, ultrasonic motion detectors in alarm systems only detect sound waves that are produced by someone walking, loud noises, or moving objects. The motion detectors currently used tend to fail in properly detecting intruders. For example, an intruder may walk very slowly and quietly to ensure that the current detectors are not set off.

As can be seen, there is a need for a more effective detective device.

### SUMMARY OF THE INVENTION

In one aspect of the present invention, a detection device comprises: a housing comprising an ultrasonic sound wave transmitter and an ultrasonic sound wave receiver, wherein the ultrasonic sound wave transmitter is configured to transmit ultrasonic sound waves to an object and the ultrasonic sound wave receiver is configured to receives a reflection of the ultrasonic sound waves and compile a data of the sound waves; a processor and memory operatively connected to the detection device, wherein the processor receives the data and determines a distance between the object and the housing and stores the distance on the memory; and an alarm system operatively connected to the computer, wherein the alarm system is activated when the computer receives the data and determines the distance has changed from the stored distance.

In another aspect of the present invention, a method of setting off an alarm comprises: (a) providing a detection device comprising an ultrasonic sound wave transmitter and an ultrasonic sound wave receiver; (b) transmitting an ultrasonic sound wave from the ultrasonic sound wave transmitter; (c) receiving the sound wave reflected from an object with the ultrasonic sound wave receiver; (d) determining the distance between the object and the detection device using the sound waves; (e) repeating steps (b) through (d); and (f) triggering an alarm system when the distance between the object and the detection device changes.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is a front view of the present invention;

FIG. 4 is a back view of the present invention; and

FIG. 5 is a side view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an alarm system with a detecting device. The detecting device includes an ultrasonic sound wave transmitter and receiver. The transmitter transmits an ultrasonic sound, an object reflects the ultrasonic sound, and the receiver receives the ultrasonic sound. A distance is determined between the object and the detecting device and is stored. The detecting device continually determines the distance using the ultrasonic sound waves and if a different distance is detected, the detecting device triggers an alarm.

The present invention may include an intruder detection device that may be used with an alarm system. In certain embodiments, the present invention may determine the distance of the detector to a wall or other object. Therefore, the detector may detect an intruder by detecting a person or object that is closer to the detector than the wall or original object. If the detector senses an intruder, the alarm may be set off. In certain embodiments, a security camera may be added to the present invention and may start recording when the present invention has been triggered to record the intruder for future investigation.

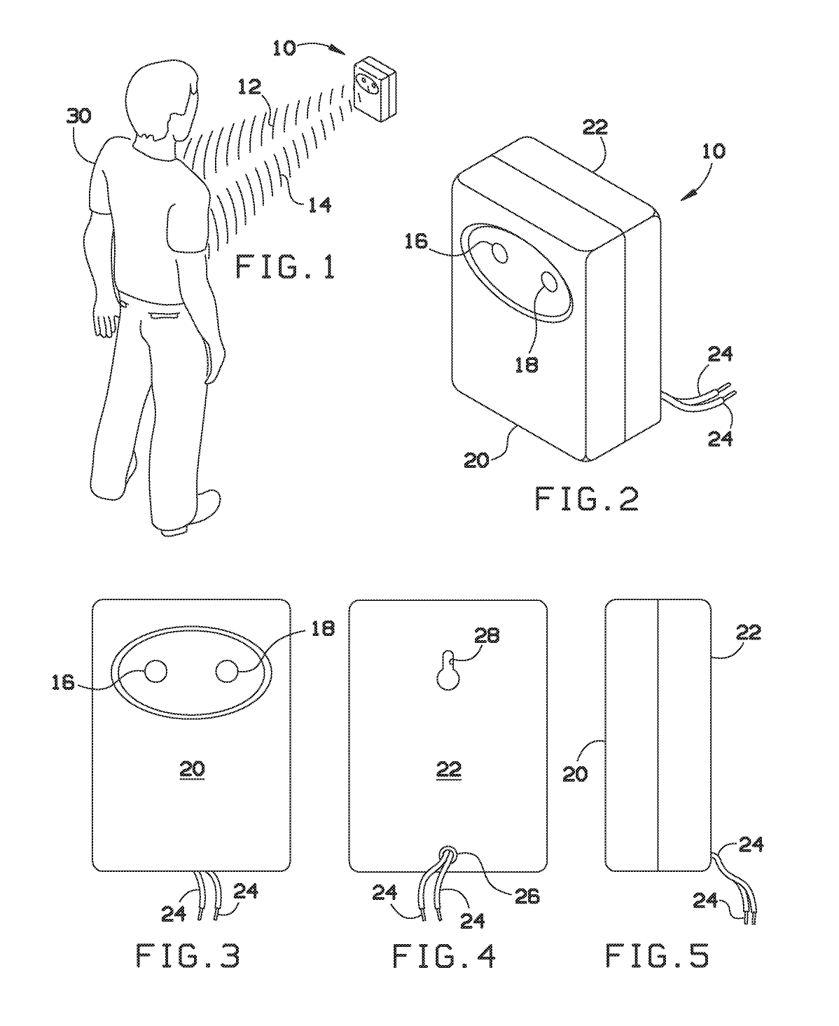

Referring to FIG. 1 through 5, the present invention may include a detection device assembly 10. The detection device assembly 10 may include a housing with a front surface 20 and a rear surface 22. In certain embodiments, the detection device assembly 10 may further include an ultrasonic sound wave transmitter 16 and an ultrasonic sound wave receiver 18. The ultrasonic sound wave transmitter 16 and the ultra sonic sound wave receiver 18 may be located on the front surface 20 of the detection device assembly.

The detection device assembly 10 of the present invention may detect a distance of an object. For example, the ultrasonic sound wave transmitter 16 may transmit sound waves 12 which may hit the object. The sound waves may reflect off of the object. The reflected sound waves 14 may be detected by the ultrasonic sound wave receiver 18. The distance of the object from the detection device assembly 10 may be calculated by using the amount of time it takes for the receiver 18 to receive the sound waves 14. A microprocessor within the detection device assembly 10 may calculate the distance. An alarm system may be within the detection device 10 or external, in which the alarm system is wired or wirelessly connected to the detection device 10.

The present invention may include connection wires 24 to connect to at least one of a power source, an external alarm system, and an external computer. The present invention may further include an opening 26 on the rear surface 22 so that the wires may pass from the inside to the outside of the detection device assembly 10. The present invention may further include a wall mount 28. The wall mount 28 may be on the rear surface 22 of the detection device assembly 10. Therefore, a user may mount the detection device assembly 10 on a wall and the transmitter 16 and the receiver 18 may be faced away from the wall.

The detection device 10 of the present invention may transmit ultrasonic sound waves 12 and receive the ultrasonic waves 14 to determine, the distance of a wall or other object. When the alarm system is being armed, detection device 10 may transmit ultrasonic sound waves 12, to measure the distance from the detection device 10 to a wall or other object. Then the detection device 10 may record the distance from the detection device 10 to a wall or other object, in the detector's memory. Then after the alarm system has been armed the ultrasonic distance estimator sends an ultrasonic sound wave 12, to measure the distance from the detector to a wall or other object. The detection device 10 may continue to check the distance to ensure that the distance reading is the same. When the detection device 10 measures the distance from the detector to a wall or other object while the alarm system is armed, the detector may verify the new measurement against the original measurement that was recorded when the alarm was being armed to ensure that it is the same. Then if the detection device 10 reads a different distance then the original distance measured, the detection device 10 may trigger the alarm system.

In alternative embodiments, the present invention may use laser beam projector device or any other device or system to estimate the distance from the detection device 10 to a wall or other object, allowing the laser beam projecting device or other device or system to perform the same function. The present invention may be installed in a home or business, as part of an alarm system that may be installed by an alarm system installer.

The present invention may also be reconfigured with a GPS device and installed on an wall mount, pedestal, or the like and may pan or tilt or do both randomly. In certain embodiments, the present invention may also be attached to an electronic robot or drone that may patrol a closed business wirelessly or on a wall ,ceiling, floor or other located built in track to detect intruders. The detecting device may record the distance from the detector to a wall or other object as well as the exact GPS location to allow the electronic robot to come back to that exact GPS location to measure the distance to the wall or other object and to verify the measurement against the measurement that is stored on to the detector's internal memory to ensure that the distance at that location is the same. If the distance did change at that location then this will indicate that there is an intruder and the alarm system may be triggered.

It should be understood, of course, that the foregoing relates to exemplary embodiments of the invention and that modifications may be made without departing from the spirit and scope of the invention as set forth in the following claims.

What is claimed is:

1. A detection device comprising:
a housing comprising an ultrasonic sound wave transmitter and an ultrasonic sound wave receiver, wherein the ultrasonic sound wave transmitter is configured to transmit ultrasonic sound waves to an object and the ultrasonic sound wave receiver is configured to receives a reflection of the ultrasonic sound waves and compiles a data of the sound waves;
a processor and memory operatively connected to the detection device, wherein the processor receives the data and determines a distance between the object and the housing and stores the distance on the memory; and
an alarm system operatively connected to the computer, wherein the alarm system is activated when the computer receives the data and determines the distance has changed from the stored distance.

2. The detection device of claim 1, wherein the housing further comprises a front surface and a rear surface.

3. The detection device of claim 2, wherein the front surface comprises the ultrasonic sound wave transmitter and the ultrasonic sound wave receiver.

4. The detection device of claim 2, wherein the rear surface comprises a wall mount

5. The detection device of claim 2, further comprising a plurality of wires to operatively connect the detection device to at least one of a computer, a power source, and an alarm system.

6. The detection device of claim 5, wherein the rear surface comprises an opening whereby the wires protrude from an inside of the housing to an outside of the housing.

7. A method of setting off an alarm comprising:
(a) providing a detection device comprising an ultrasonic sound wave transmitter and an ultrasonic sound wave receiver;
(b) transmitting an ultrasonic sound wave from the ultrasonic sound wave transmitter;
(c) receiving the sound wave reflected from an object with the ultrasonic sound wave receiver;
(d) determining the distance between the object and the detection device using the sound waves;
(e) repeating steps (b) through (d); and
(f) triggering an alarm system when the distance between the object and the detection device changes.
